(19) United States
(12) Patent Application Publication
(10) Pub. No.: US 2006/0161552 A1
(43) Pub. Date: Jul. 20, 2006

(54) Monitoring system

(76) Inventor: David John Jenkins, Felbridge (GB)

Correspondence Address: CHRISTIE, PARKER & HALE, LLP, PO BOX 7068, PASADENA, CA, 91109-7068, US

(21) Appl. No.: 11/039,648

(22) Filed: Jan. 18, 2005

(51) Int. Cl. G06F 17/30

(52) U.S. Cl. 707/10

(57) ABSTRACT

A monitoring system is disclosed, suitable particularly for a prison or similar environment, comprising a network having at least two computers, one or more condition-sensing and or monitoring devices, the system being arranged to enable any one of the computers to act as a server at any time, comprising a hierarchical list installed on each computer listing the priority by which the computers can become servers and a priority of threads operating on each computer, said priority of threads including a first thread arranged to check whether each other computer is active and a second thread adapted to use the hierarchical list and data determined via the first thread to determine which computer is to be used as a server.

### BACKGROUND OF THE INVENTION

This invention relates to a monitoring system. In particular, but not exclusively, it relates to a system for monitoring activity over a distributed environment such as a workplace, residential or study environment and most preferably the invention relates to the monitoring of a secure environment such as a prison or other secure environment.

A secure environment such as a prison will generally comprise one or a plurality of buildings, each of which has several rooms and corridors and which will be monitored by various types of equipment, including CCTV cameras, fire sensors, smoke sensors, access control apparatus, pagers and other electronic surveillance and/or monitoring equipment. The system will also comprise viewing means for selectively viewing outputs from these sensors or other monitoring or surveillance systems and computer equipment for controlling and analysing all the data to present it meaningfully to a user.

In a typical such environment, a server will be used as the central control and surveillance hub. Often one, or more usually several, client computers, such as personal computers (PCs) may also be distributed around the network. Often the computers and server will be connected via a computer network such as an IP/TCP, Ethernet or wireless network. Such systems can work well but are susceptible to failure of components and, in particular, to failure of the server or to a network failure causing access to the server to be restricted or blocked. These problems may be minimised by the use of duplicate servers or by using technology such as RAID (redundant array of independent discs).

These can increase costs, however, and do not fully solve the problems, particularly if either network failure or physical conditions such as fire, prevent access to the or each dedicated server on the system, in which case RAID arrays would not solve the problem.

The present invention arose in an attempt to provide an improved monitoring system.

### BRIEF SUMMARY OF THE INVENTION

According to the present invention there is provided a monitoring system comprising a network having at least two computers, one or more condition sensing and or monitoring devices and means for enabling any one of the computers to act as a server at any time and for any one of the other computers to become the server if the first server becomes unable to act as a server.

In a fixer aspect the invention provides a method of controlling a monitoring and/or surveillance network, comprising providing at least two computers and means for enabling any of the computers at any time to be used as a server to control the system, said means including means for determining which of the computers is to be used as a server at any time depending upon a hierarchical list and data representative of the activity and availability of each computer.

According to the present invention in a yet further aspect there is provided a monitoring and/or surveillance system comprising at least one sensor or surveillance device and a migrating server.

The invention yet further provides a monitoring system comprising a network having at least two computers, one or more condition sensing and or monitoring devices and means for enabling any one of the computers to act as a server at any time, which means comprising a hierarchical list installed on each computer listing the priority by which the computers can become servers and a priority of threads operating on each computer, said priority of threads including a first thread arranged to check whether each other computer is active and a second thread adapted to use the hierarchical list and data determined via the first thread to determine which computer is to be used as a server. The invention is of particular benefit to secure environments such as prisons, personnel-holding facilities or other secure places.

### SUMMARY OF THE DRAWINGS

Embodiments of the invention will now be described, by way of example only, with reference to the accompanying drawings, in which:

FIG. 1 shows a monitoring and surveillance system for a secure environment;

FIG. 2 shows part of a control system; and

FIG. 3 is a flowchart illustrating a migrating server technique.

### DETAILED DESCRIPTION OF EMBODIMENTS OF THE INVENTION

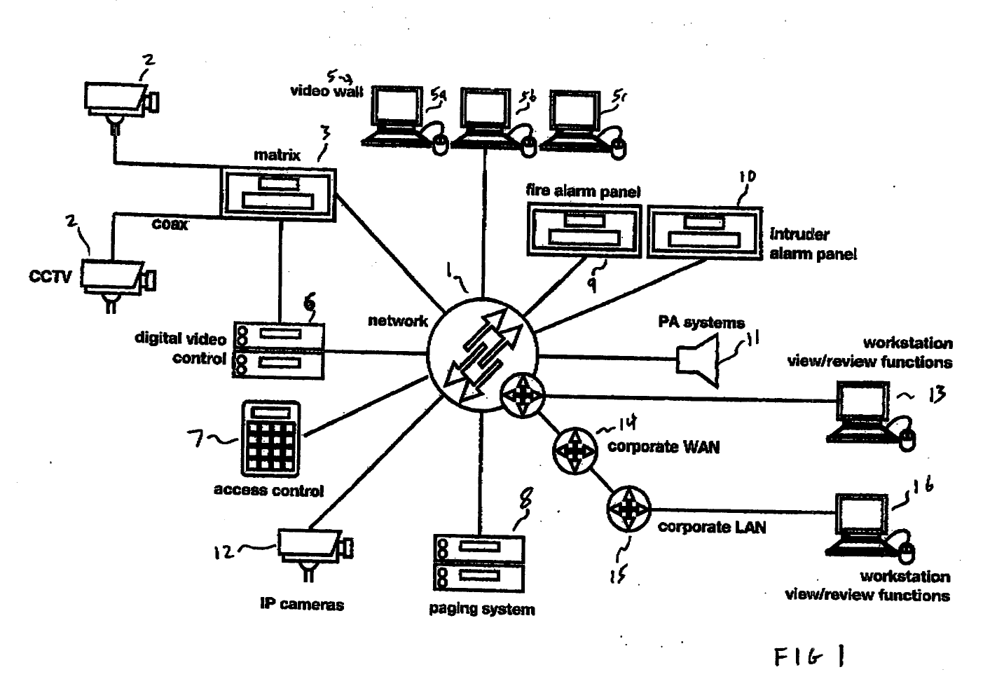

Referring to FIG. 1, a monitoring and/or surveillance system for use in a secure environment such as a prison is shown. The system comprises a plurality of sensors, surveillance devices and other types of equipment connected via a network to a control system, shown generally as network 1.

The system shown is by way of example only and many different types of configuration may be used but in the one shown in FIG. 1, the system comprises a number of closed circuit television cameras (CCTVS) 2 connected to a camera matrix 3. A digital video control apparatus 4 is connected to this and the network is such that it can control both the movement, scanning and imaging of the camera. Images from the cameras can be viewed in real time, or as recorded video, on a video wall 5 which generally will comprise a plurality of display screens 5a, 5b and 5c or may instead comprise just a single display screen. The TV cameras may be analogue or digital and images may be viewed from them in real time, or delayed still or moving video images may be stored. The apparatus may also include access control means 7, such as keypads, finger print readers, retune scanners and various control means, locking mechanisms, etc at locations through the secure area, such as doors, cells, corridors, etc.

A paging system 8 is also connected to the network and in a prison environment the individual prison officers may carry portable pagers. The paging system may also include means for location sensing and means for detecting if an officer is in a desired or undesired location, for example, or may be in trouble because he has been at particular location for longer than was envisaged. The location sensing system may use triangulation techniques e.g. using a system of locally mounted transmitters/receivers or other methods, using local or remote devices, or positioning systems such as GPS.

The system may also advantageously have integrated within it fire alarm and intruder alarm systems and a fire alarm panel 9 and intruder alarm panel 10 are shown.

An intercom system, such as a PA system 11 with speakers and perhaps also microphones to allow two-way communication is also included.

In addition to the CCTV cameras, the figure also shows an IP (Internet Protocol) camera 12 which may be remotely located and perhaps connected over a wide area network such as the Internet, communicating by Internet Protocol standards for example. The figure further shows the first work station 13 with viewing and reviewing function for giving an overall view of the situation.

The monitoring and surveillance apparatus shown may form part of a wider corporate wide area network (1) 14 and of course can be at a physically separate location. A further corporate LAN 15 may include one or more workstations 16 which can also be used to view data from the monitoring and surveillance systems.

The surveillance system represents a plurality of components which are connected together in the network. This may include some items which are connected together by a wired bus or other types of networking, such as Ethernet networks, and of course may include wireless devices connected via wireless communication systems such as WI-FI™, Optical Systems, Bluetooth™ or other wireless communication methods.

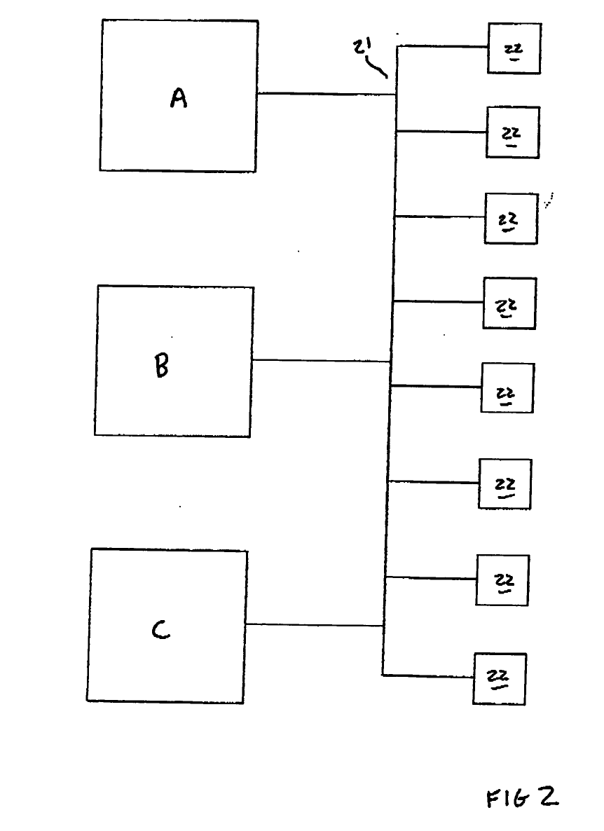

FIG. 2 shows schematically part of the control and monitoring apparatus and this comprises three computers respectively marked computer A, computer B and computer C. Each of these computers are connected to the network bus 21 and a plurality of sensing, surveillance or monitoring equipment 22 is also connected to the bus. The bus may of course be an Ethernet connection or may represent more generally a network such as a network running IP/TCP internet protocols or other packet or non-packet based protocols.

The units 22 may be a monitor, surveillance or control equipment, non-limiting examples of which are shown in the example of FIG. 1.

Previously proposed monitoring system utilised one of the computers, say computer A for example, as a server. The other computers could be used to view and monitor the environment and may be able to control local devices connected to them but were not acting in a server capacity.

In the present invention, at one time, one of the computers A, B or C, say computer A, will act as a server and the remaining computers B and C will act as client machines. However, if for any reason computer A cannot act as a server, either through a problem at the computer itself or through a network problem, or an external environmental problem, then the server function ‘migrates’ to one or the other computers B and C. Note that although three computers are shown in figure, in practice there may be any number of computers or just two computers, in the system. All or a selected group of these computers may become servers if necessary.

The system embodying the present invention utilises a hierarchial list of machines (computers) that can become servers.

A more detailed explanation follows, with reference to the drawings:

A list of IP addresses for all relevant machines that can become a server is stored on each computer. The order of the list identifies the order in which machines should become a server. For example, if the list contains the IP addresses for machine A, machine B and machine C—in that order—then if machine A is active it will be the server. If machine A is inactive and machine B is active, then machine B will be the server. If only machine C is active then that will be the server. Each computer maintains a list of which possible server machines are currently active. If machine A is active then a flag for server machine 1 will be set—and similarly for all other listed server machines. Therefore if server machine 1 is flagged as active the PC that is server machine 1 will become a server and all other machine will connect to it. If server machine 1 becomes inactive at any time then all machines will switch to using the next highest active server machine.

A single software application can create any number of ‘threads’. A ‘thread’ is a section of code which, to all intents and purposes, runs simultaneously to all other threads within the application. Code within a thread runs concurrently in a logical manner. The migrating server networking according to a preferred embodiment uses tree threads to achieve the above functionality:

1. The first networking thread continuously loops through the list of servers and checks to see if the system is still active on each machine. To do this it uses a ‘sockets’ code to call up the remote computer and ask for a response. A sockets code is an object that connects an application to a network protocol. For example a program can send or receive TCP/IP messages by opening a socket and reading and writing data to and from the socket, The sockets code is essentially Microsoft™ sockets code, but the timing is preferably such that the code quickly reports if the machine replied or not (within a time less than 30 seconds)—a failure to respond could otherwise take over 30 seconds. As each machine is checked the result is stored in a thread-safe area of data indicating whether that machine responded—and therefore is available—or not.

2. A second thread constantly listens for incoming connection requests. When another PC attempts to connect, the connection is accepted. This indicates to the other PC that this machine is active. The connection is then closed and the thread waits for other connection attempts.

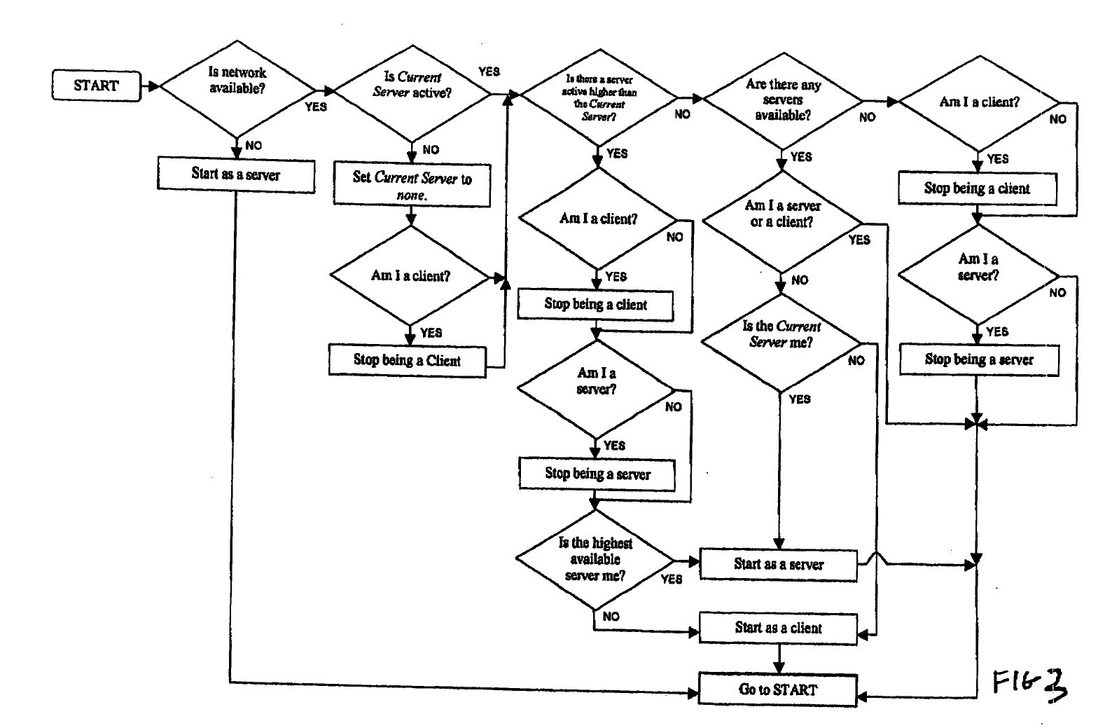

3. A final thread deals with making the machine operate as a server or client, depending on the status flags obtained from the first thread. The flow chart of FIG. 3 shows how this works. The flow chart makes use of two sections of data—the list of currently active servers (maintained by thread 1), and a record of which machine is running as a server now (current server in the flow chat). If the machine that is running as a server now is flagged as inactive then the server machine will change. Similarly if the currently running server is still flagged as active, but a server higher in the list becomes available, then the server machine will change.

Server Operation

The server machine is simply a nominated computer that listens for incoming network connections from other machines. When the server machine hears a connection request from another computer it verifies and accepts the connection and adds that connection to the list of clients that are connected to it.

When data is required to be sent to all networked machines the data is simply sent out to all machines in the server's current list of clients.

When data is received from a connected client machine it is first sent out to all other client machines and then processed by the server.

When a machine first becomes a server it will open up connections to all external hardware and start communicating with them according to their specific protocols. When an event happens on any of the external hardware that is important to the system, e.g. the hardware shown in FIG. 1, this event is sent to all connected clients. When the user performs an action that affects any of the external hardware this event is sent directly to the hardware using the relevant protocol.

Client Operation

A machine becomes a client when it successfully connects to the server machine over the network. To become a client a connection request is sent to the server. When the connection request is accepted by the server the client machine stores the connection as its current server.

When data is required to be sent to all networked machines the data is only sent to the server, The server will then forward the data on to all other clients.

When data is received from the server the client machine will simply process it. A client machine will not attempt to open up connections to any external hardware. If any connections to hardware are open then they will be shut down, enabling the server to gain access to them When an event happens on any of the external hardware the server machine will notify the client machine. When the user performs an action on the client machine that affects any of the external hardware, the event is sent to the server machine which will then pass it on to the hardware using the relevant protocol.

The ‘migrating-server’ routine is illustrated in the flow chart of FIG. 3 and the following table.

Migrating Server Example

PSMx=Possible Server Machine, x=priority number of server.

List of possible servers, configured identically on each machine:

IP Address 192.168.0.10 (Machine A—PSM1)

IP Address 192.168.0.15 (Machine B—PSM2)

IP Address 192.168.0.20 (Machine C—PSM3)

TABLE A

| Machine A | Machine B | Machine C |
|---|---|---|
| Inactive | Active | Inactive |
| Thread 1 - Not running. | Thread 1: | Thread 1 - Not running. |
| | PSM1 - Inactive. | |
| | PSM2 - Active (me). | |
| | PSM3 - Inactive. | |
| Thread 2 - Not running. | Thread 2: Listens for | Thread 2 - Not running. |
| Thread 3 - Not running | Thread 3: Highest available | Thread 3 - Not running. |
| | server is PSM2. | |
| | Am I PSM2? Yes. | |
| | Am I a server? No - | |
| | become a server. | |
| Inactive | Active | Active |
| Thread 1 - Not running. | Thread 1: | Thread 1: |
| | PSM1 - Inactive. | PSM1 - Inactive. |
| | PSM2 - Active (me). | PSM2 - Active. |
| | PSM3 - Active. | PSM3 - Active (me). |
| Thread 2 - Not running. | Thread 2: Listens for | Thread 2: Listens for |
| | incoming connections. | incoming connections. |
| | Connection request | Connection request |
| | from Machine C. | from Machine B. |
| Thread 3 - Not running. | Tread 3: Highest available | Thread 3: Highest available |
| | server is PSM2. | server is PSM2. |
| | Am I PSM2? Yes - | Am I PSM2? No - |
| | check Pm a server. | check Pm a client. |
| | Am I a server? Yes - | Am I server? No - |
| | do nothing. | do nothing. |
| | Am I a client? No - | Am I a client? No - |
| | do nothing. | become a client of |
| | | PSM2. |
| Active | Active | Active |
| Thread 1: | Thread 1: | Thread 1: |
| PSM1 - Active (me). | PSM1 - Active. | PSM1 - Active. |
| PSM2 - Active. | PSM2 - Active (me). | PSM2 - Active. |
| PSM3 - Active. | PSM3 - Active. | PSM3 - Active (me). |
| Thread 2: Listens for | Thread 2: Listens for | Thread 2: Listens for |
| incoming connections, | incoming connections. | incoming connections. |
| Connection request | Connection request | Connection request |
| from Machine B. | from Machine A. | from Machine A. |
| Connection request | Connection request | Connection request |
| from Machine C. | from Machine C. | from Machine B. |
| Thread 3: Highest available | Thread 3: Highest available | Thread 3: Highest available |
| server is PSM1. | server is PSM1. | server is PSM1. |
| Am I PSM1? Yes. | Am I PSM1? No. | Am I PSM1? No - |
| Am I a server? No - | Am I a server? Yes - | check I'm a client. |
| become a server. | stop being a server. | Am I a server? No - |
| | Am I a client? No - | do nothing. |
| | become a client of | Am I a client? Yes. |
| | PSM1. | Is my current server |
| | | PSM1? No - stop |
| | | being a client of |
| | | PSM2 and become a |
| | | client of PSM1. |

Note that in this specification the term computer may extend to any apparatus having a processor. The term prison used herein may mean a dedicated prison facility or any facility used or usable to detain persons.

1. A monitoring system comprising a network having at least two computers, one or more condition sensing and or monitoring devices, the computers being arranged to enable any one of the computers to act as a server at any time and for any one of the other computers to become the server if the first server becomes unable to act as a server.

2. A monitoring system as claimed in claim 1 including a hierarchical list of the priority by which the computers can become the server.

3. A monitoring system as claimed in claim 2 wherein the hierarchical list contains the IP addresses of each computer.

4. A monitoring system as claimed in claim 1 wherein a priority of threads are run on each computer, the threads being used to achieve states in which one computer acts as a server and the remainder of the computers act as clients.

5. A monitoring system as claimed in claim 4 when each computer includes a list of the addresses of each other computer and comprising a first thread acting to check whether each other computer is active.

6. A monitoring system as claimed in claim 5 wherein the first thread uses a sockets code.

7. A monitoring system as claimed in claim 4 comprising a second thread arranged to listen for connection requests from other computers.

8. A monitoring system as claimed in claim 7 wherein the second thread monitors attempts to connect with the computer on which the thread is running from another computer and acceptance of said connection, thereby to indicate to the computer on which the thread is running that the computer attempting to connect with that computer is active.

9. The monitoring system as claimed in claim 5 comprising a hard thread usable to select whether a computer operates as a server or client.

10. A monitoring system as claimed in claim 9 wherein the first thread is used to identify if a contacted computer replies or not and sets a status flag accordingly and the third flag uses the status flag at least partially as a basis to determine whether the machine it is running on is to act as a server or client.

11. A monitoring system as claimed in claim 10 wherein in the third thread uses a list of currently active servers and a record of which machine is currently acting as server to determine whether the computer on which the thread is running should now become a server if the computer currently running as a server is indicated as being inactive.

12. A monitoring system as claimed in claim 11 wherein if the currently running server is considered to be active but a further computer which is higher in the hierarchial list of computers becomes available, then that further computer becomes the server.

13. A monitoring system as claimed in claim 1 wherein when a computer first becomes a server it opens connections to the other connectors and devices on the network and begins communicating with them according to their specific protocols.

14. A method of controlling a monitoring and/or surveillance network, comprising providing at least two computers and means for enabling any of the computers at any time to be used as a server to control the system, said means including means for determining which of the computers is to be used as a server at any time depending upon a hierarchical list and data representative of the activity and availability of each computer.

15. A monitoring and or surveillance device comprising at least one sensor or surveillance device and a migrating server.

16. A monitoring system comprising a network having at least two computers, one or more condition sensing and or monitoring devices and the computers being arranged to enable any one of the computers to act as a server at any time, the system comprising a hierarchical list installed on each computer listing the priority by which the computers can become servers and a priority of threads operating on each computer, said priority of threads including a first thread arranged to check whether each other computer is active and a second thread adapted to use the hierarchical list and data determined via the first thread to determine which computer is to be used as a server.

17. A monitoring system as claimed in claim 16 wherein a further thread is provided which continuously checks connection requests from other computers or devices.

18. A monitoring system as claimed in claim 1, used in a prison, the condition sensing and monitoring devices including surveillance devices.

19. A monitoring system as claimed in class 16, used in a prison environment, the condition-sensing and monitoring device including surveillance devices system.
